(19) United States
(12) Patent Application Publication
(10) Pub. No.: US 2007/0186216 A1
(43) Pub. Date: Aug. 9, 2007

(54) MESSAGE DRIVEN JOB PROCESSING SYSTEM AND METHOD

(76) Inventor: Mustafa Seifi, Irvine, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/692,675

(22) Filed: Mar. 28, 2007

Related U.S. Application Data
(63) Continuation-in-part of application No. 10/156,443, filed on May 28, 2002.

(51) Int. Cl. G06F 9/46

(52) U.S. Cl. 718/102

(57) ABSTRACT

The subject application is directed to a message driven job processing system and method. Electronic documents are first stored in an associated memory. At least one document processing operation, corresponding to the stored electronic documents, is then associated with each of a plurality of job processing components. A job processing message is then sent to each job processing component. Each job processing component then commences at least one document processing operation on an electronic document upon the receipt of the job processing message. Job status data is then received from each job processing component corresponding to the status of the processing operation being performed by the job processing component.

### CROSS-REFERENCE TO RELATED APPLICATIONS

This Application is a Continuation-in-Part of U.S. patent application Ser. No. 10/156,443, titled, METHOD AND IMPLEMENTATION FOR MESSAGE-DRIVEN JOB PROCESSING, filed on May 28, 2002, the entirety of which is incorporated herein.

### BACKGROUND OF THE INVENTION

The subject application is directed to a message driven job processing system and method. More particularly, the subject application is directed to a message driven system and method for processing document processing requests. In particular, the subject application is directed to a system and method for processing electronic documents in a queue using messages communicated between components of an associated document processing device.

In a network, it is common to process jobs, e.g. printing jobs, in a queue. Jobs are assigned a position in the queue and a network device, e.g. a network printer, processes each of the jobs in a predetermined order. For example, the jobs can be processed in the order they have been received. Also, the jobs can be processed in accordance with priority, with high priority jobs being given preference.

In a network, the operation of the queue can be implemented in a number of different ways. In one common previous-type method of processing jobs in a queue, the system constantly loops through all the jobs in the queue to insure that the jobs are being processed quickly. However, this method requires that the queue be monitored at all time, even when no jobs are waiting to be processed. This approach therefore uses up lots of CPU time by monitoring the queue at all times, and therefore inefficiently manages system resources.

In another previous-type method of job processing, a “daemon” process can be implemented that “wakes up” in predefined time intervals and processes any jobs that are waiting in the queue. While this method puts less demand on the CPU, it suffers from the drawback that jobs may sit idle for an undesirable period of time until the daemon process wakes up to service the waiting jobs. In this way, this approach is inefficient at managing the performance of the system.

### SUMMARY OF THE INVENTION

In accordance with one embodiment of the subject application, there is provided a message driven job processing system and method.

Further, in accordance with one embodiment of the subject application, there is provided a message driven system and method for processing document processing requests.

Still further, in accordance with one embodiment of the subject application, there is provided a system and method for processing electronic documents in a queue using messages communicated between components of an associated document processing device.

Further, in accordance with one embodiment of the subject application, there is provided a message driven job processing system. The system includes memory adapted for storing a plurality of electronic documents. The system also includes a plurality of job processing components in data communication with the memory. Each job processing component is adapted to perform at least one document processing operation on the electronic documents communicated thereto. Each job processing component of the system also includes means adapted for commencing at least one document processing operation upon receipt of a job processing message. The system further comprises a job manager, which includes message transmission means adapted for sending at least one job processing message to each job processing component, wherein receipt of such job processing message commences processing of at least one electronic document disposed in the memory. The job manager also includes means adapted for receiving job status data from each job processing component, and enablement means adapted for enabling the message transmission means so as to send a job processing message to each component upon each receipt of job status data.

In one embodiment of the subject application, the job status data corresponds to a state change of at least one processing component.

In another embodiment of the subject application, the state change corresponds to at least one of commencement of job processing and a completion of job processing by an associated processing component.

In yet another embodiment of the subject application, each job processing message is communicated to a job processing component corresponding to an electronic document stored in the memory.

In one embodiment of the subject application, the enablement means further comprises means adapted for enabling the message transmission means when no job status data has been received for a selected interval. In such an embodiment, the selected interval is defined as when a difference between a current time and a selected time value exceeds a time duration from which most recent job status data was received.

Still further, in accordance with one embodiment of the subject application, there is provided a message driven job processing method in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a message driven job processing system according to one embodiment of the subject application;

FIG. 2 is a block diagram illustrating components of the message driven job processing system according to one embodiment of the subject application;

FIG. 3 is a block diagram illustrating controller hardware for use in the message driven job processing system according to one embodiment of the subject application;

FIG. 4 is a functional diagram illustrating the controller for use in the message driven job processing system according to one embodiment of the subject application;

FIG. 5 is a flowchart illustrating a message driven job processing method according to one embodiment of the subject application; and

FIG. 6 is a flowchart illustrating a message driven job processing method according to one embodiment of the subject application.

### DETAILED DESCRIPTION OF THE PREFERRED EMBODIMENT

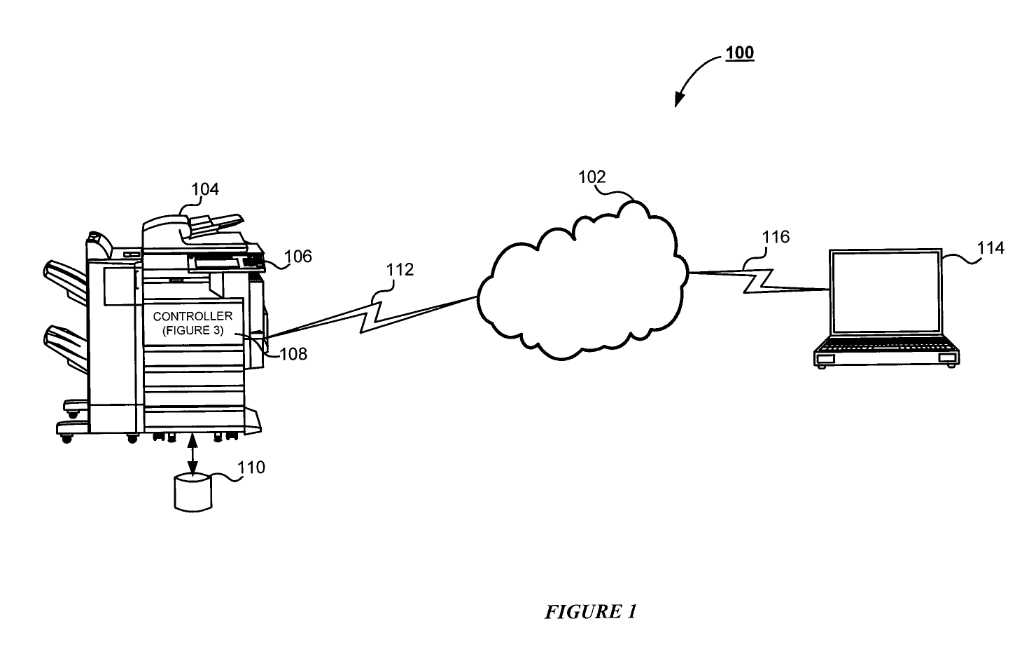

The subject application is directed to a message driven job processing system and method In particular, the subject application is directed to a message driven system and method for processing document processing requests. More particularly, the subject application is directed to a system and method for processing electronic documents in a queue using messages communicated between components of an associated document processing device. It will become apparent to those skilled in the art that the system and method described herein are suitably adapted to a plurality of varying electronic fields employing message driven job processing, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a message driven job processing system 100 in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more 15 electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

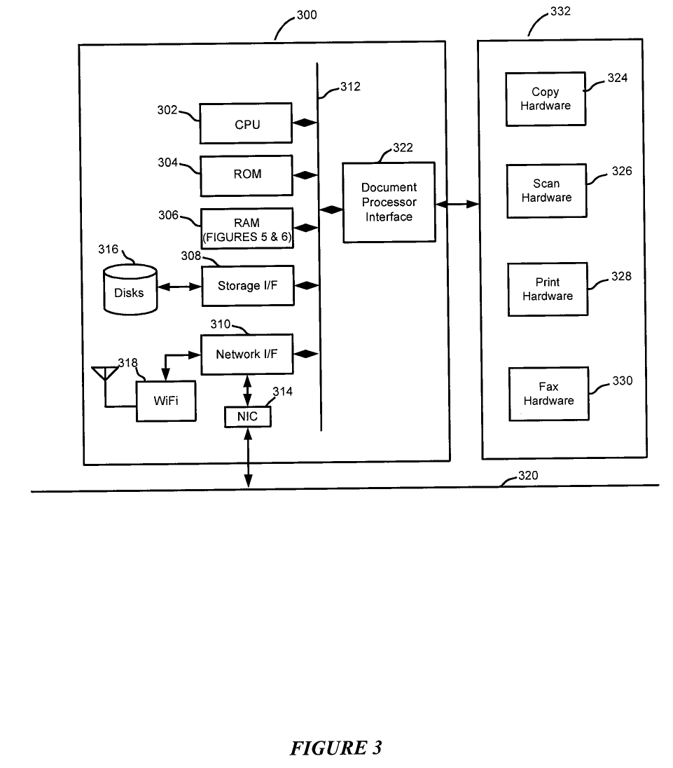

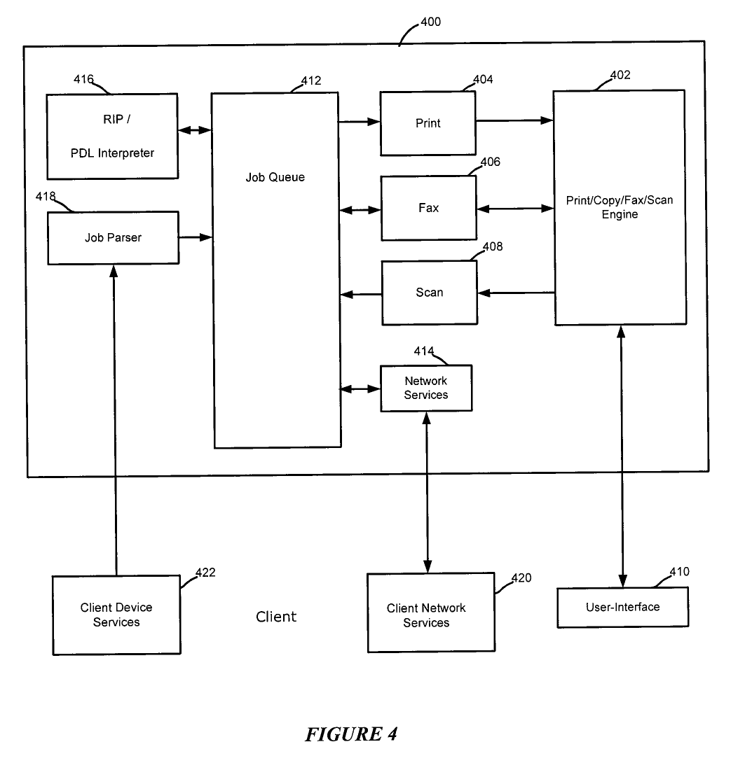

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the message driven job processing system and method of the subject application. The functioning of the controller 108 will better be understood in conjunction with the block diagrams illustrated in FIGS. 3 and 4, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store a document data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like. In accordance with one embodiment of the subject application, the data storage device 110 includes a job queue, functioning to store a plurality of electronic documents received by the associated document processing device as document processing requests.

The system 100 illustrated in FIG. 1 further depicts a user device 114, in data communication with the computer network 102 via a communications link 116. It will be appreciated by those skilled in the art that the user device 114 is shown in FIG. 1 as a laptop computer for illustration purposes only. As will be understood by those skilled in the art, the user device 114 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 114 is suitably adapted to generate and transmit electronic documents, document processing instructions, user interface modifications, upgrades, updates, personalization data, or the like, to the document processing device 104, or any other similar device coupled to the computer network 102.

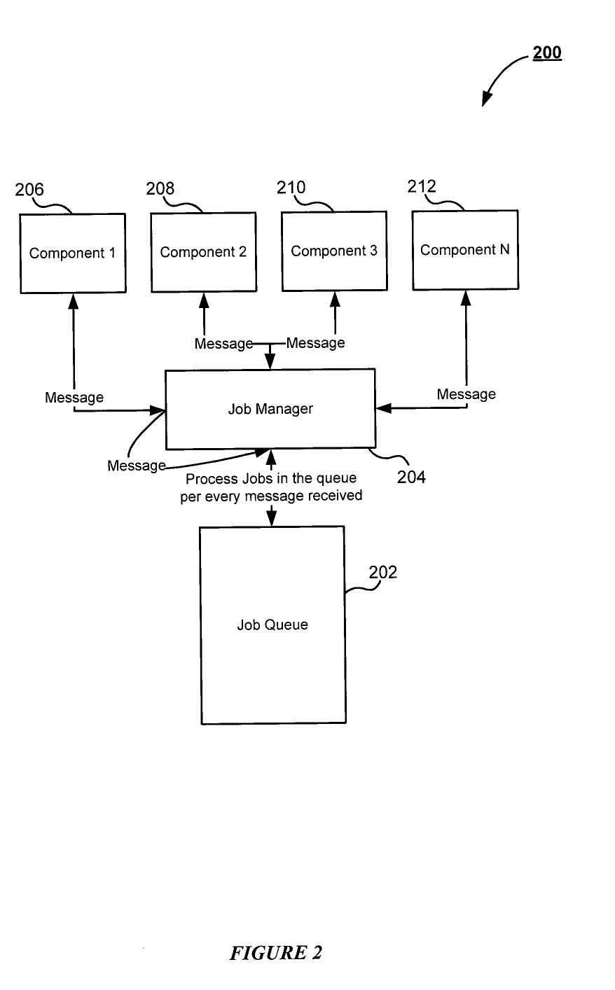

Referring now to FIG. 2, there is shown a block diagram 200 illustrating various component interactions in accordance with the system 100 of FIG. 1. The skilled artisan will appreciate that the depiction in FIG. 2 is for illustration purposes only, and the various components described therein correspond to hardware, software, or any suitable combination thereof, capable of performing the functions as described in greater detail below. The diagram 200 includes a job queue 202 in message-based communication with a job manager 204. In accordance with one embodiment of the subject application, the job queue 202 includes electronic document processing requests received from associated users. Each request preferably includes an electronic document and at least one document processing operation to be performed thereon. The job queue 202 is referenced more fully in FIG. 4, described in greater detail below. The diagram further illustrates a plurality of job processing components 206, 208, 210, and 212, each corresponding to at least one document processing operation. The job processing components 206-212 are capable of implementation as hardware, software, or any suitable combination thereof. Preferably, the job processing components 206-212 are in message-based communication with the job manager 204, which communications includes the transmission of job processing status messages, as will be understood by those skilled in the art. The functioning of the various components described in FIG. 2 is explained in greater detail below.

Turning now to FIG. 3, illustrated is a representative architecture of a suitable backend component, i.e., the controller 300, shown in FIG. 1 as the controller 108, on which operations of the subject system 100 are completed. The skilled artisan will understand that the controller 108 is representative of any general computing device, known in the art, capable of facilitating the methodologies described herein. Included is a processor 302, suitably comprised of a central processor unit. However, it will be appreciated that processor 302 may advantageously be composed of multiple processors working in concert with one another as will be appreciated by one of ordinary skill in the art. Also included is a non-volatile or read only memory 304 which is advantageously used for static or fixed data or instructions, such as BIOS functions, system functions, system configuration data, and other routines or data used for operation of the controller 300.

Also included in the controller 300 is random access memory 306, suitably formed of dynamic random access memory, static random access memory, or any other suitable, addressable and writable memory system. Random access memory provides a storage area for data instructions associated with applications and data handling accomplished by processor 302.

A storage interface 308 suitably provides a mechanism for non-volatile, bulk or long term storage of data associated with the controller 300. The storage interface 308 suitably uses bulk storage, such as any suitable addressable or serial storage, such as a disk, optical, tape drive and the like as shown as 316, as well as any suitable storage medium as will be appreciated by one of ordinary skill in the art.

A network interface subsystem 310 suitably routes input and output from an associated network allowing the controller 300 to communicate to other devices. The network interface subsystem 310 suitably interfaces with one or more connections with external devices to the device 300. By way of example, illustrated is at least one network is interface card 314 for data communication with fixed or wired networks, such as Ethernet, token ring, and the like, and a wireless interface 318, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 314 is interconnected for data interchange via a physical network 320, suitably comprised of a local area network, wide area network, or a combination thereof.

Data communication between the processor 302, read only memory 304, random access memory 306, storage interface 308 and the network interface subsystem 310 is suitably accomplished via a bus data transfer mechanism, such as illustrated by bus 312.

Also in data communication with bus the 312 is a document processor interface 322. The document processor interface 322 suitably provides connection with hardware 332 to perform one or more document processing operations. Such operations include copying accomplished via copy hardware 324, scanning accomplished via scan hardware 326, printing accomplished via print hardware 328, and facsimile communication accomplished via facsimile hardware 330. It is to be appreciated that the controller 300 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 300 of FIG. 3, (shown in FIG. 1 as the controller 108) as an intelligent subsystem associated with a document processing device. In the illustration of FIG. 4, controller function 400 in the preferred embodiment, includes a document processing engine 402. A suitable controller functionality is that incorporated into the Toshiba e-Studio system in the preferred embodiment. FIG. 4 illustrates suitable functionality of the hardware of FIG. 3 in connection with software and operating system functionality as will be appreciated by one of ordinary skill in the art.

In the preferred embodiment, the engine 402 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 402 is suitably interfaced to a user interface panel 410, which panel allows for a user or administrator to access functionality controlled by the engine 402. Access is suitably enabled via an interface local to the controller, or remotely via a remote thin or thick client.

The engine 402 is in data communication with the print function 404, facsimile function 406, and scan function 408. These functions facilitate the actual operation of printing, facsimile transmission and reception, and document scanning for use in securing document images for copying or generating electronic versions.

A job queue 412, shown in FIG. 2 at 202, is suitably in data communication with the print function 304, facsimile function 406, and scan function 408. It will be appreciated that various image forms, such as bit map, page description language or vector format, and the like, are suitably relayed from the scan function 308 for subsequent handling via the job queue 412.

The job queue 412 is also in data communication with network services 414. In a preferred embodiment, job control, status data, or electronic document data is exchanged between the job queue 412 and the network services 414. Thus, suitable interface is provided for network based access to the controller function 400 via client side network services 420, which is any suitable thin or thick client. In the preferred embodiment, the web services access is suitably accomplished via a hypertext transfer protocol, file transfer protocol, uniform data diagram protocol, or any other suitable exchange mechanism. The network services 414 also advantageously supplies data interchange with client side services 420 for communication via FTP, electronic mail, TELNET, or the like. Thus, the controller function 400 facilitates output or receipt of electronic document and user information via various network access mechanisms.

The job queue 412 is also advantageously placed in data communication with an image processor 416. The image processor 416 is suitably a raster image process, page description language interpreter or any suitable mechanism for interchange of an electronic document to a format better suited for interchange with device functions such as print 404, facsimile 406 or scan 408.

Finally, the job queue 412 is in data communication with a parser 418, which parser suitably functions to receive print job language files from an external device, such as client device services 422. The client device services 422 suitably include printing, facsimile transmission, or other suitable input of an electronic document for which handling by the controller function 400 is advantageous. The Parser 418 functions to interpret a received electronic document file and relay it to the job queue 412 for handling in connection with the afore-described functionality and components.

In operation, a plurality of electronic documents is first stored in an associated memory. At least one document processing operation, corresponding to the stored electronic documents, is then associated with each of a plurality of job processing components. A job processing message is then sent to each job processing component. Each job processing component then commences at least one document processing operation on an electronic document upon the receipt of the job processing message. Job status data is then received from each job processing component corresponding to the status of the processing operation being performed by the job processing component.

In accordance with one example embodiment of the subject application, a document processing request, inclusive of an electronic document and a document processing operation to be performed thereon, is received by a document processing device 104. The skilled artisan will appreciate that such a request is capable of originating from a user associated with the user device 114, via the computer network 102, a user accessing the document processing device 104 via the associated user interface 106, an electronic mail message received via the computer network 102, or the like. A job manager 204, a controller 108 or other suitable component associated with the document processing device 104 transfers the received document processing request, or processing job, to a job queue 202, resident on the document processing device 104. The skilled artisan will appreciate that such a job manager 204 is any hardware, software, or suitable combination thereof, suitably adapted for facilitating the management of received document processing requests. In accordance with one embodiment of the subject application, the job manager 204 is a software component resident on the controller 108 associated with the document processing device 104. According to one embodiment of the subject application, the job queue 202 is located in memory associated with the document processing device 104, e.g., the data storage device 110.

A determination is then made with respect to the newly received document processing request as to which document processing operation(s) have been requested. In accordance with one embodiment of the subject application, such a determination is capable of being performed by the job manager 204, the controller 108, or other suitable component associated with the document processing device 104. The suitable component of the document processing device 104, e.g., the job manager 204, the controller 108, or the like, then identifies the one or more job processing components 206-212 that are associated with the document processing operations requested. As will be understood by those skilled in the art, a job processing component 206-212 is any hardware, software, or combination thereof, resident on the document processing device suitably adapted for performing one or more associated document processing operations. For example and without limitation, suitable job processing components include a printing component, a copying component, a facsimile component, a text recognition component, a scanning component, and the like. Preferably, each of the job processing components 206-212 includes at least one associated document processing operation capable of being performed, fully or in part, thereon. Once the job processing component or components 206-212 have been identified, the job manager 204 sends a message to the identified components 206-212 to begin processing the document processing request in the job queue 202.

The job manager 204 then analyzes the queue 202 to determine whether any additional document processing requests remain in the job queue 202. When the job manager 204 locates additional document processing requests resident in the job queue 202, the manger 204 identifies the job processing components 206-212 associated with the document processing operations corresponding to the next document processing request in the queue 202. Thereafter, the job manager 204 sends a message to the identified job processing components 206-212 to begin processing the next document processing request in the queue 202.

When the job manager 204 determines that no additional jobs remain in the queue 202, a determination is made whether any status messages have been received from any job components 206-212. In accordance with one embodiment of the subject application, the status message includes job status data, corresponding to a state change of a corresponding job processing component 206-212, e.g., job commenced, job completed, job error, or the like. When no status messages have been received by the job manager 204, the manager 204 waits a selected or predefined interval. In accordance with one embodiment of the subject application, the selected interval is defined as when a difference between a current time and a selected time value exceeds a time duration from which the most recent job status data was received. The expiration of this predefined interval prompts the job manager 204 to identify any and all document processing requests resident in the job queue 202, their associated components 206-212, and communicate a message to the identified components 206-212 to process the corresponding document processing requests. When the job manager 204 determines that a status message has been received from one of the job components 206-212, the job manager 204 processes the message, e.g., determines the type of message, the document processing request associated with the component 206-212, the type of operations, or the like. In the event that the message received from the component 206-212 is indicative of an error that has occurred during the performance of the requested operation, the job manager 204 reports the error to the user associated with the request, an administrator, or the like. The job manager 204 then updates the job queue 202 in accordance with the received status message. Thus, for example, when an error has been reported, the document processing request corresponding to the reported error is updated or removed from the job queue 202 to reflect the error. Thereafter, the job manager 204 analyzes the job queue 202 to determine if any document processing requests remain, which prompts the identification of the associated components 206-212 and the transmission of messages to the components 206-212 from the job manager 204 with respect to processing the document processing request.

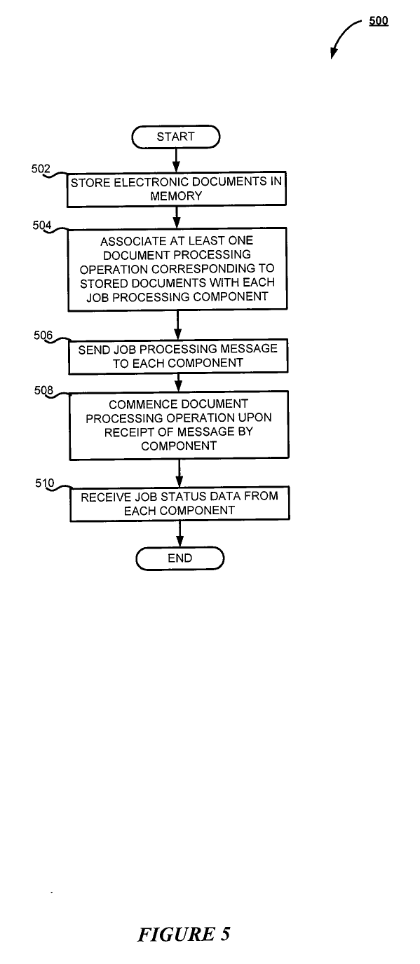

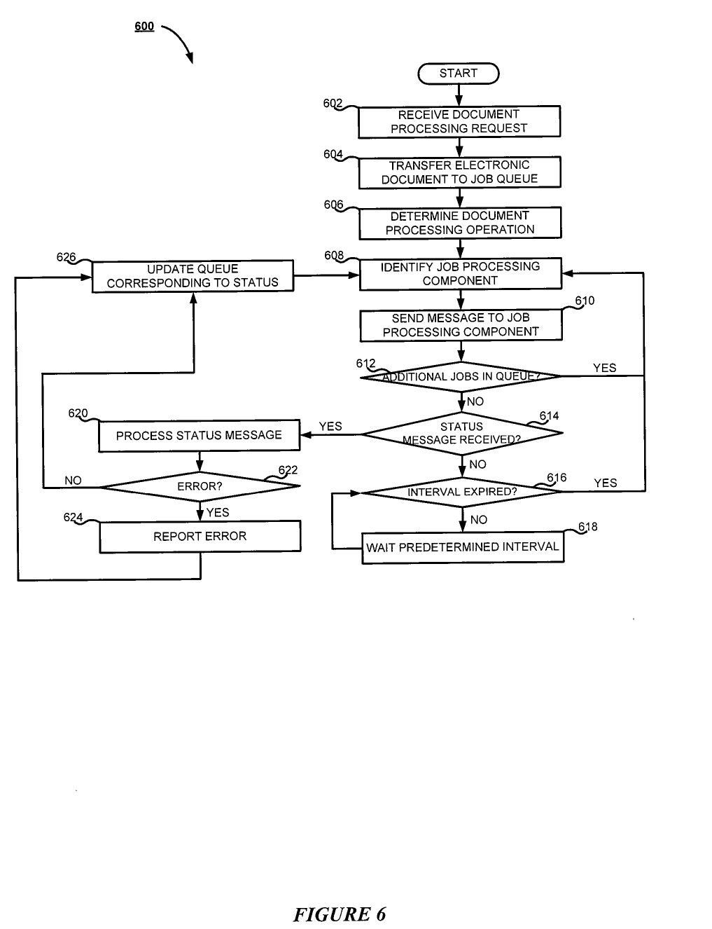

The skilled artisan will appreciate that the subject system 100 and components described above with respect to FIG. 1, FIG. 2, FIG. 3, and FIG. 4 will be better understood in conjunction with the methodologies described hereinafter with respect to FIG. 5 and FIG. 6. Turning now to FIG. 5, there is shown a flowchart 500 illustrating a message driven document processing method in accordance with one embodiment of the subject application. Beginning at step 502, a plurality of electronic documents are stored in an associated memory, e.g., a job queue 202 associated with the document processing device 104. In accordance with one embodiment of the subject application, the document processing device 104 receives document processing requests, for example, from the user device 114, inclusive of one or more electronic documents and associated requested document processing operations to be performed on the electronic documents. The document processing requests are then added to the job queue 202, which is capable of residing on the data storage device 110 associated with the document processing device 104.

At step 504, at least one document processing operation, corresponding to the received and stored electronic documents, is associated with each job processing component 206-212. The job manager 204, controller 108, or other suitable component of the document processing device 104, then sends a job processing message to each job processing component 206-212 at step 506. The job processing components 206-212 then commence, at step 508, document processing operations upon receipt of the job processing message from the job manager 204. The job manager 204 then receives, at step 510, status messages from each of the job processing components 206-212. In accordance with one embodiment of the subject application, each status message includes status data corresponding to a state change associated with the job processing component 206-212 originating the status message.

Referring now to FIG. 6, there is shown a flowchart 600 illustrating a message driven job processing method in accordance with one embodiment of the subject application. The method depicted in FIG. 6 begins at step 602, whereupon a document processing request, inclusive of an electronic document and one or more associated document processing operations, is received by the document processing device 104. A job manger 204, a controller 108, or other suitable component associated with the document processing device 104 then transfers the document processing request to a job queue 202 at step 604. It will be appreciated by those skilled in the art that the job queue 202 is capable of implementation on the data storage device 110 associated with the document processing device 104. The requested document processing operation or operations are then determined at step 606 in accordance with the received document processing request.

The job manager 204 then identifies, at step 608, the job processing component or components 206-212 associated with the determined document processing operations corresponding to the document processing request. In accordance with one embodiment of the subject application, the job manager 204 resides on the controller 108 as software/hardware thereof, associated with the document processing device 104. The job manager 204, at step 610, sends a message, via any suitable means known in the art, to the identified job processing components 206-212 corresponding to the received document processing request.

Following transmission of the message to the identified job processing components 206-212, the job manager 204 determines, at step 612, whether any additional document processing requests, i.e., electronic documents, remain pending in the job queue 202. When the job manager 204 locates one or more electronic documents in the job queue 202, flow returns to step 608, whereupon the job manager 204 begins processing of all jobs currently in the job queue 202 with the identification of job processing components 206-212 associated with the electronic documents. A message is then sent to the identified job processing components 206-212 indicative of the pending document processing request, i.e., the electronic document in the queue 202. When no additional electronic documents remain in the queue 202, flow proceeds to step 614, whereupon the job manager 204 determines whether any status messages have been received from any of the job processing components 206-212.

When the job manager 204 determines that no status messages have been received, flow progresses to step 616, whereupon a determination is made whether a selected time interval has expired. For example, the job manager 204 determines whether or not a predefined period of time has elapsed since the last time that a status message was received. When the interval has not expired, the job manager 204 waits the predetermined interval at step 618 until such time as a determination is made at step 616 that the interval has lapsed. Upon a determination that the selected interval has expired, flow returns to step 608, whereupon the job manager 204 begins processing of all jobs located in the job queue 202 by identifying job processing components 206-212 associated with current document processing requests. Thereafter, operations continue in accordance with the method described above.

Returning to step 614, when it is determined that a status message has been received, flow proceeds to step 620, whereupon the job manager 204 processes the received status message. When it is determined, at step 622, that the received message corresponds to an error message, e.g., out of paper condition, paper jam condition, or the like, the associated error is reported out at step 624 to a corresponding user, administrator, log, or the like. Thereafter, the job queue 202 is updated at step 626 to reflect the status. Similarly, when the status message does not correspond to an error, flow proceeds to step 626, whereupon the job queue 202 is updated to reflect the current status of a job, based upon the message returned from the job processing component 206-212 to the job manager 204. Flow then returns to step 608, whereupon the job manager 204 begins processing any and all jobs currently in the job queue 202. Operations then continue from step 608 in accordance with the methodology described in greater detail above.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the is subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A message driven job processing system comprising:
a memory adapted for storing a plurality of electronic documents;
a plurality of job processing components in data communication with the memory, each job processing component being adapted to perform at least one document processing operation on electronic documents communicated thereto;
each job processing component including means adapted for commencing at least one document processing operation upon receipt of a job processing message; and
a job manager including,
message transmission means adapted for sending at least one job processing message to each job processing component, wherein receipt of such job processing message commences processing of at least one electronic document disposed in the memory,
means adapted for receiving job status data from each job processing component, and
enablement means adapted for enabling the message transmission means so as to send a job processing message to each component upon each receipt of job status data.

2. The message driven job processing system of claim 1 wherein the job status data corresponds to a state change of at least one processing component.

3. The message driven job processing system of claim 2 wherein the state change corresponds to at least one of commencement of job processing and a completion of job processing by an associated processing component.

4. The message driven job processing system of claim 3 wherein each job processing message is communicated to a job processing component corresponding to an electronic document stored in the memory.

5. The message driven job processing system of claim 1 wherein the enablement means further comprises means adapted for enabling the message transmission means when no job status data has been received for a selected interval.

6. The message driven job processing system of claim 5 wherein the selected interval is defined as when a difference between a current time and a selected time value exceeds a time duration from which most recent job status data was received.

7. A message driven job processing method comprising the steps of:
storing a plurality of electronic documents in an associated memory;
associating at least one document processing operation corresponding to the stored electronic documents with each of a plurality of job processing components;
sending at least one job processing message to each job processing component;
commencing at least one document processing operation via each job processing component on the at least one electronic document upon receipt of a job processing message; and
receiving job status data from each job processing component.

8. The message driven job processing method of claim 7 wherein the job status i5 data corresponds to a state change of at least one processing component.

9. The message driven job processing method of claim 8 wherein the state change corresponds to at least one of commencement of job processing and a completion of job processing by an associated processing component.

10. The message driven job processing method of claim 9 wherein each job processing message is communicated to a job processing component corresponding to an electronic document stored in the memory.

11. The message driven job processing method of claim 7 further comprising the step of sending at a message when no job status data has been received for a selected interval.

12. The message driven job processing method of claim 11 wherein the selected interval is defined as when a difference between a current time and a selected time value exceeds a time duration from which most recent job status data was received.
